(19) United States
(12) Patent Application Publication
(10) Pub. No.: US 2006/0216508 A1
(43) Pub. Date: Sep. 28, 2006

(54) Polymer nanocomposite having surface modified nanoparticles and methods of preparing same

(75) Inventors: Igor Y. Denisyuk, St. Petersburg (RU); Todd R. Williams, Lake Elmo, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/089,319

(22) Filed: Mar. 24, 2005

(51) Int. Cl. B32B 5/16

(52) U.S. Cl. 428/402; 523/200

(57) ABSTRACT

Disclosed herein is a nanocomposite containing a plurality of nanoparticles, each nanoparticle containing at least one metal sulfide nanocrystal having a surface modified with a carboxylic acid, wherein the carboxylic acid has at least one aryl group; and an organic matrix. Also disclosed is a method of preparing the nanocomposite, the method consisting of: (a) providing a plurality of nanoparticles, each nanoparticle containing at least one metal sulfide nanocrystal having a surface modified with a carboxylic acid, wherein the carboxylic acid has at least one aryl group; (b) providing an organic matrix that is a radiation curable monomer, a radiation curable oligomer, or mixtures thereof; and (c) mixing the plurality of nanoparticles with the organic matrix to effect dissolution of the plurality of nanoparticles. Also disclosed is a second method of preparing the nanocomposite wherein (b) consists of providing an organic matrix that is a thermoplastic polymer.

### CROSS-REFERENCE TO RELATED APPLICATIONS

This application is related to commonly assigned, co-pending U.S. Patent Applications:

Ser. No. ______ by Denisiuk et al., entitled “Surface Modified Nanoparticle and Method of Preparing Same”, and filed of even date herewith (Docket 60352); and

Ser. No. ______ by Denisiuk et al., entitled “Method of Preparing Polymer Nanocomposite Having Surface Modified Nanoparticles”, and filed of even date herewith (Docket 60462).

### FIELD OF THE INVENTION

The present disclosure relates to a nanocomposite, and particularly to a polymer nanocomposite comprising a plurality of surface modified nanoparticles. Methods of preparing the nanocomposite are also disclosed.

### BACKROUND

Nanocomposites are mixtures of at least two different components wherein at least one of the components has one or more dimensions in the nanometer region. Nanocomposites have found use in many applications because, for example, they exhibit properties attributable to each of its components. One type of nanocomposite comprises nanoparticles distributed in an organic matrix such as a polymer. This type of nanocomposite is useful in optical applications, wherein the nanoparticles are used to increase the refractive index of the polymer. The nanoparticles must be uniformly distributed with minimal coagulation within the polymer, such that the nanocomposite exhibits minimal haze due to light scattering.

There is a need for nanocomposites that can be readily prepared and that are suitable for use in optical applications.

### SUMMARY

The present disclosure relates to a nanocomposite comprising a plurality of nanoparticles, each nanoparticle comprising at least one metal sulfide nanocrystal having a surface modified with a carboxylic acid, wherein the carboxylic acid comprises at least one aryl group; and an organic matrix.

The present disclosure also relates to a method of preparing the nanocomposite, the method comprising: (a) providing a plurality of nanoparticles, each nanoparticle comprising at least one metal sulfide nanocrystal having a surface modified with a carboxylic acid, wherein the carboxylic acid comprises at least one aryl group; (b) providing an organic matrix comprising a radiation curable monomer, a radiation curable oligomer, or mixtures thereof; and (c) mixing the plurality of nanoparticles with the organic matrix to effect dissolution of the plurality of nanoparticles.

The present disclosure also relates to a method of preparing the nanocomposite, the method comprising: (a) providing a plurality of nanoparticles, each nanoparticle comprising at least one metal sulfide nanocrystal having a surface modified with a carboxylic acid, wherein the carboxylic acid comprises at least one aryl group; (b) providing an organic matrix comprising a thermoplastic polymer; and (c) mixing the plurality of nanoparticles with the organic matrix to effect dissolution of the plurality of nanoparticles.

The nanocomposite disclosed herein may be used in a variety of applications such as optical applications.

### DETAILED DESCRIPTION

The present disclosure relates to a nanocomposite comprising a plurality of nanoparticles, each nanoparticle comprising at least one metal sulfide nanocrystal having a surface modified with a carboxylic acid, wherein the carboxylic acid comprises at least one aryl group. Useful nanoparticles are disclosed in Ser. No. ______ by Williams et al., entitled “Surface Modified Nanoparticle and Methods of Preparing Same”, and filed of even date herewith (Docket 60352), the disclosure of which is hereby incorporated by reference. The nanoparticles may be prepared by the method:
(a) providing a first solution of a first organic solvent comprising a non-alkali metal salt and a carboxylic acid, wherein the carboxylic acid comprises at least one aryl group dissolved therein;
(b) providing a sulfide material; and
(c) combining the first solution and the sulfide material to form a reaction solution, thereby forming a nanoparticle comprising at least one metal sulfide nanocrystal having a surface modified with the carboxylic acid, wherein the carboxylic acid comprises at least one aryl group.
   The method may further consist of:
(d) precipitating the nanoparticle by adding a third solvent to the reaction solution, wherein the third solvent is miscible with the first organic solvent but is a poor solvent for the nanoparticle;
(e) isolating the nanoparticle;
(f) optionally washing the nanoparticle with the third solvent; and
(g) drying the nanoparticle to powder.

The first organic solvent may be any organic solvent capable of dissolving the non-alkali metal salt and the carboxylic acid comprising at least one aryl group, and it must also be compatible with the sulfide material to form the reaction solution in which the nanoparticles are formed. In one embodiment, the first organic solvent is a dipolar, aprotic organic solvent such as dimethylformamide, dimethylsulfoxide, pyridine, tetrahydrofuran, 1,4-dioxane, N-methylpyrrolidone, propylene carbonate, or mixtures thereof.

The non-alkali metal salt provides metal ions that combine stoichiometrically with the sulfide material to form the metal sulfide nanocrystals. The particular choice of non-alkali metal salt may depend upon the solvents and/or the carboxylic acid comprising at least one aryl group used in the methods described above. For example, in one embodiment, the non-alkali metal salt is a salt of a transition metal, a salt of a Group IIA metal, or mixtures thereof, because metal sulfide nanocrystals of these metals are easy to isolate when water is used as the third solvent. Examples of transition metals and Group IIA metals are Ba, Ti, Mn, Zn, Cd, Zr, Hg, and Pb.

Another factor that influences the choice of the non-alkali metal salt is the desired properties of the metal sulfide nanocrystals, and therefore, the desired properties of the nanoparticles. For example, if the nanocomposite is for an optical application, then the non-alkali metal salt may be a zinc salt because zinc sulfide nanocrystals are colorless and have a high refractive index. For semiconductor applications, the non-alkali metal salt may be a cadmium salt because cadmium sulfide nanocrystals can absorb and emit light in useful energy ranges.

The carboxylic acid comprising at least one aryl group modifies the surface of the at least one metal sulfide nanocrystal. The particular choice of carboxylic acid comprising at least one aryl group may depend upon the solvents and the non-alkali metal salt used in the methods described above. The carboxylic acid comprising at least one aryl group must dissolve in the first organic solvent and must be capable of surface modifying the at least one metal sulfide nanocrystal that forms upon combination of the first solution with the sulfide material. Selection of the particular carboxylic acid comprising at least one aryl group may also depend upon the intended use of the nanoparticles. For use in nanocomposites, the carboxylic acid comprising at least one aryl group may aid compatibility of the nanoparticles with the organic matrix into which they are blended. In one embodiment, the carboxylic acid comprising at least one aryl group has a molecular weight of from 60 to 1000 in order to be soluble in the first organic solvent and give nanoparticles that are compatible with a wide variety of organic matrices.

In another embodiment, the carboxylic acid comprising at least one aryl group is represented by the formula:
Ar—L¹—CO₂H
wherein L¹ comprises an alkylene residue of from 1 to 10 C atoms, and wherein the alkylene residue is saturated, unsaturated, straight-chained, branched, or alicyclic; and
Ar comprises a phenyl, phenoxy, naphthyl, naphthoxy, fluorenyl, phenylthio, or naphthylthio group.
   The alkylene residue may be methylene, ethylene, propylene, butylene, or pentylene. If the alkylene residue has greater than 5 C atoms, solubility in the first organic solvent may be limited and/or surface modification may be less effective. The alkylene residue and/or the aryl group may be substituted with alkyl, aryl, alkoxy, halogen, or other groups. The carboxylic acid comprising at least one aryl group may be 3-phenylpropionic acid; 4-phenylbutyric acid; 5-phenylvaleric acid; 2-phenylbutyric acid; 3-phenylbutyric acid; 1-napthylacetic acid; 3,3,3-triphenylpropionic acid; triphenylacetic acid; 2-methoxyphenylacetic acid; 3-methoxyphenylacetic acid; 4-methoxyphenylacetic acid; 4-phenylcinnamic acid; or mixtures thereof.

In another embodiment, the carboxylic acid comprising at least one aryl group is represented by the formula:
Ar—L²—CO₂H
wherein L² comprises a phenylene or napthylene residue; and
Ar comprises a phenyl, phenoxy, naphthyl, naphthoxy, fluorenyl, phenylthio, or naphthylthio group.
   The phenylene or napthylene residue and/or the aryl group may be substituted with alkyl, aryl, alkoxy, halogen, or other groups. The carboxylic acid comprising at least one aryl group may be 2-phenoxybenzoic acid; 3-phenoxybenzoic acid; 4-phenoxybenzoic acid; 2-phenylbenzoic acid; 3-phenylbenzoic acid; 4-phenylbenzoic acid; or mixtures thereof.

In the first solution, useful weight ratios of the carboxylic acid comprising at least one aryl group to the non-alkali metal salt are from 1:2 to 1:200. The mole ratio of the carboxylic acid comprising at least one aryl group to the non-alkali metal salt may be less than 1:10. The particular weight ratio used will depend on a variety of factors such as the solubilities of the carboxylic acid comprising at least one aryl group and the non-alkali metal salt, the identity of the sulfide material, the reaction conditions, e.g. temperature, time, agitation, etc.

The sulfide material provides sulfide that stoichiometrically reacts with the non-alkali metal ions to form the at least one metal sulfide nanocrystal. In one embodiment, the sulfide material comprises hydrogen sulfide gas that may be bubbled through the first solution. In another embodiment, the sulfide material comprises a second solution of a second organic solvent containing hydrogen sulfide gas or sulfide ions dissolved therein, wherein the second organic solvent is miscible with the first organic solvent. Useful second organic solvents are methanol, ethanol, isopropanol, propanol, isobutanol, or mixtures thereof. The second solution of sulfide ions may be obtained by dissolution of a sulfide salt in the second organic solvent; useful sulfide salts are an alkali metal sulfide, ammonium sulfide, or a substituted ammonium sulfide. It is often useful to limit the amount of sulfide material to 90% of the stoichiometric equivalent of the non-alkali metal ions. In one embodiment, the first solution comprises non-alkali metal ions dissolved therein, and the second solution comprises sulfide ions dissolved therein, and the mole ratio of the non-alkali metal ions to the sulfide ions is 10:9 or more.

The nanoparticles used in the nanocomposite disclosed herein comprise at least one metal sulfide nanocrystal. In one embodiment, the metal sulfide nanocrystals are transition metal sulfide nanocrystals, Group IIA metal sulfide nanocrystals, or mixtures thereof. In another embodiment, the metal sulfide nanocrystals comprise zinc metal sulfide nanocrystals. In yet another embodiment, the mineral form of the zinc metal sulfide nanocrystals is sphalerite crystal form, because sphalerite crystal form has the highest refractive index compared to other mineral forms of zinc sulfide, and so is very useful in nanocomposites for optical applications.

The nanoparticles comprise at least one metal sulfide nanocrystal, and the exact number of nanocrystals may vary depending on a variety of factors. For example, the number of nanocrystals in each nanoparticle may vary depending on the particular choice of the non-alkali metal salt, the carboxylic acid comprising at least one aryl group, or the sulfide material, as well as their concentrations and relative amounts used in (a), (b), or (c). The number of nanocrystals in each nanoparticle may also vary depending on reaction conditions used in (a), (b), or (c); examples of reaction conditions include temperature, time, and agitation, etc. All of these aforementioned factors may also influence shape, density, and size of the nanocrystals, as well as their overall crystalline quality and purity. The number of metal sulfide nanocrystals may vary for each individual nanoparticle in a given reaction solution, even though the nanoparticles are formed from the same non-alkali metal ions and sulfide material, and in the same reaction solution.

The at least one metal sulfide nanocrystal has a surface modified by the carboxylic acid comprising at least one aryl group. The number of surfaces may vary depending on the factors described in the previous paragraph, as well as on the particular arrangement of nanocrystals within the nanoparticle if more than one nanocrystal is present. One or more individual carboxylic acid molecules may be involved in the surface modification, and there is no limit to the particular arrangement and/or interaction between the one or more carboxylic acid molecules and the at least one metal sulfide nanocrystal as long as the desired properties of the nanoparticle are obtained. For example, many carboxylic acid molecules may form a shell-like coating that encapsulates the at least one metal sulfide nanocrystal, or only one or two carboxylic acid molecules may interact with the at least one metal sulfide nanocrystal.

The nanoparticles may have any average particle size depending on the particular application. As used herein, average particle size refers to the size of the nanoparticles that can be measured by conventional methods, which may or may not include the carboxylic acid comprising at least one aryl group. The average particle size may directly correlate with the number, shape, size, etc. of the at least one nanocrystal present in the nanoparticle, and the factors described above may be varied accordingly. In general, the average particle size may be 1 micron or less. In some applications, the average particle size may be 500 nm or less, and in others, 200 nm or less. If used in nanocomposites for optical applications, the average particle size is 50 nm or less in order to minimize light scatter. In some optical applications, the average particle size may be 20 nm or less.

Average particle size may be determined from the shift of the exciton absorption edge in the absorption spectrum of the nanoparticle in solution. Results are consistent with an earlier report on ZnS average particle size—(R. Rossetti, Y. Yang, F. L. Bian and J. C. Brus, J. Chem. Phys. 1985, 82, 552). Average particle size may also be determined using transmission electron microscopy.

The nanoparticles may be isolated by using any conventional techniques known in the art of synthetic chemistry. In one embodiment, the nanoparticles are isolated as described in (d) to (g) above. The third solvent is added to the reaction solution in order to precipitate the nanoparticles. Any third solvent may be used as long as it is a poor solvent for the nanoparticles and a solvent for all the other components remaining in the reaction solution. A poor solvent may be one that can dissolve less than 1 weight % of its weight of nanoparticles. In one embodiment, the third solvent is water, a water miscible organic solvent, or mixtures thereof. Examples of water miscible organic solvents include methanol, ethanol, and isopropanol.

The nanoparticles may be isolated by centrifugation, filtration, etc., and subsequently washed with the third solvent to remove non-volatile by-products and impurities. The nanoparticles may then be dried, for example, under ambient conditions or under vacuum. For some applications, removal of all solvents is critical. For nanocomposites used in optical applications, residual solvent may lower the refractive index of the nanoparticles, or cause bubbles and/or haze to form within the nanocomposite.

The present disclosure relates to a nanocomposite comprising the nanoparticles described above and an organic matrix. The organic matrix may be a polymer such as a thermoplastic polymer, a thermoset polymer, or mixtures thereof. In any case, the polymer may have any structural composition, for example, it may be an addition polymer formed by addition of unsaturated monomers via a free radical or cationic mechanism, or it may be a condensation polymer formed by the elimination of water between monomers. The polymer may also be random, block, graft, dendrimeric, etc.

In one embodiment, the polymer may be a polyolefin, polystyrene, polyacrylate, polymethacrylate, polyacrylic acid, polymethacrylic acid, polyether, polybutadiene, polyisoprene, polyvinylchloride, polyvinylalcohol, polyvinyl acetate, polyester, polyurethane, polyurea, polycarbonate, polyamide, polyimide, polyepoxide, cellulose, or mixtures thereof. In another embodiment, the polymer may be a copolymer of a polyolefin, polystyrene, polyacrylate, polymethacrylate, polyacrylic acid, polymethacrylic acid, polyether, polybutadiene, polyisoprene, polyvinylchloride, polyvinylalcohol, polyvinyl acetate, polyester, polyurethane, polyurea, polycarbonate, polyamide, polyimide, polyepoxide or cellulose. For example, the copolymer may be a polyester-polyurethane, polymethacrylate-polystyrene, etc. In yet another embodiment, the polymer comprises aromatic rings, halogens, and sulfur atoms for high refractive index. An example of a useful polymer is Polycarbonate Z (Iupilon® Z-200 from Mitsubishi Gas Chemical, CAS # 25134-45-6).

In one embodiment, the organic matrix comprises a thermoplastic polymer, and the nanocomposite may be prepared by the method:
(a) providing a plurality of nanoparticles, each nanoparticle comprising at least one metal sulfide nanocrystal having a surface modified with a carboxylic acid comprising at least one aryl group;
(b) providing an organic matrix comprising a thermoplastic polymer; and
(c) mixing the plurality of nanoparticles with the organic matrix to effect dissolution of the plurality of nanoparticles.
   Mixing may be carried out using any suitable means and may depend on the physical properties of the thermoplastic polymer and the nanoparticles. Examples of suitable means include single and multiple screw extruders, multi-stage extruders, reciprocating extruders, kneaders, stirrers, processors, etc. The necessary mixing conditions, such as temperature, pressure, time, rate, etc. may also depend on the particular combination of thermoplastic polymer and nanoparticles. Suitable thermoplastic polymers and nanoparticles are described above.

In another embodiment, the organic matrix comprises a radiation curable monomer, a radiation curable oligomer, or mixtures thereof. A nanocomposite comprising such an organic matrix may be prepared by the method:
(a) providing a plurality of nanoparticles, each nanoparticle comprising at least one metal sulfide nanocrystal having a surface modified with a carboxylic acid, wherein the carboxylic acid comprises at least one aryl group;
(b) providing an organic matrix comprising a radiation curable monomer, a radiation curable oligomer, or mixtures thereof; and
(c) mixing the plurality of nanoparticles with the organic matrix to effect dissolution of the plurality of nanoparticles.

Useful radiation curable monomers and oligomers are any of those capable of forming any of the aforementioned polymers upon curing with particle, actinic, or thermal radiation. Examples of such radiation curable materials and methods are described in U.S. Pat. No. 4,559,382, the disclosure of which is hereby incorporated by reference. In one embodiment, the radiation curable monomer or the radiation curable oligomer comprises groups that are normally polymerized by free radicals, such as an acrylate, methacrylate, or styrenic group, or mixtures thereof. Particular examples of radiation-curable monomers are 2-carboxyethyl acrylate, phenoxyethylacrylate, or mixtures thereof.

In another embodiment, radiation curable monomers and oligomers are cationically polymerizable and contain at least one cationically polymerizable group such as an epoxide, cyclic ether, vinyl ether, vinylamine, unsaturated hydrocarbon, lactone or other cyclic ester, lactam, cyclic carbonate, cyclic acetal, aldehyde, cyclic amine, cyclic sulfide, cyclosiloxane, or cyclotriphosphazene. Other useful cationically polymerizable monomers and oligomers are described in G. Odian, “Principles of Polymerization” Third Edition, John Wiley & Sons Inc., 1991, N.Y.; and “Encyclopedia of Polymer Science and Engineering”, Second Edition, H. F. Mark, N. M. Bikales, C. G. Overberger, G. Menges, J. I. Kroschwitz, Eds., Vol. 2, John Wiley & Sons, 1985, N.Y., pp. 729-814. Particular examples of cationically polymerizable monomers are bisphenol A diglycidyl ether, triethylene glycol divinyl ether, or mixtures thereof.

In one embodiment, the organic matrix comprises a thermoplastic or thermoset polymer, wherein the thermoplastic or thermoset polymer is formed from a radiation curable monomer, a radiation curable oligomer, a radiation curable polymer, or mixtures thereof. Useful radiation curable monomers, oligomers, or polymers are described above. In one embodiment, the nanocomposite may be prepared by the method:
(a) providing a plurality of nanoparticles, each nanoparticle comprising at least one metal sulfide nanocrystal having a surface modified with a carboxylic acid, wherein the carboxylic acid comprises at least one aryl group;
(b) providing an organic matrix comprising a radiation curable monomer, a radiation curable oligomer, or mixtures thereof; and
(c) mixing the plurality of nanoparticles with the organic matrix to effect dissolution of the plurality of nanoparticles;
(d) adding a photoinitiator; and
(e) curing with actinic radiation.
   In another embodiment, the nanocomposite may be prepared by the method:
(a) providing a plurality of nanoparticles, each nanoparticle comprising at least one metal sulfide nanocrystal having a surface modified with a carboxylic acid, wherein the carboxylic acid comprises at least one aryl group;
(b) providing an organic matrix comprising a radiation curable monomer, a radiation curable oligomer, or mixtures thereof; and
(c) mixing the plurality of nanoparticles with the organic matrix to effect dissolution of the plurality of nanoparticles;
(d) adding a thermal initiator; and
(e) curing with thermal radiation.

When the radiation curable monomer or oligomer comprises at least one group polymerizable by free radicals, and when the curing radiation is particle radiation, e.g., gamma rays, x-rays, alpha and beta particles from radioisotopes, electron beams, and the like, no additional source of free radicals for initiating polymerization is required. Generally, the use of from 0.5 to 10 megarads of radiation is sufficient to provide cure to a final product.

When the curing energy is actinic radiation such as ultraviolet or visible radiation, or thermal radiation, it is necessary to add a source of free radicals to the composition to initiate reaction on application of curing energy. Included among free radical sources or initiators that are suitable for the compositions disclosed herein are conventional thermally activated compounds, or thermal initiators, such as organic peroxides and organic hydroperoxides. Representative examples of these are benzoyl peroxide, tertiary-butyl perbenzoate, cumene hydroperoxide, and azobis(isobutyronitrile). When the radiation is ultraviolet or visible, the initiators may be photopolymerization initiators, or photo initiators, which facilitate polymerization when the composition is irradiated. Included among these initiators are acyloin and derivatives thereof, e.g., benzoin, benzoin methyl ether, benzoin ethyl ether, benzoin isopropyl ether, benzoin isobutyl ether, and α-methylbenzoin, diketones, e.g., benzil and diacetyl, organic sulfides, e.g., diphenyl monosulfide, diphenyl disulfide, decyl phenyl sulfide, and tetramethylthiuram monosulfide, S-acyl dithiocarbamates, e.g., S-benzoyl-N,N-dimethyldithiocarbamate, phenones, e.g. acetophenone, α,α,α-tribromacetophenone, α,α-diethoxyacetophenone, o-nitro-α,α,α-tribromoacetophenone, benzophenone, and p,p′-tetramethyldiaminobenzophenone, phosphine oxides, e.g. bis(2,4,6-trimethylbenzoyl)phenylphosphine oxide, available as Irgacure® 819 from Ciba, Tarrytown, N.Y. The initiator can be used in amounts ranging from about 0.01 to 5% by weight of the total polymerizable composition. When the amount is less than 0.01% by weight, the polymerization rate will generally be too low. If the amount exceeds about 5% by weight, no correspondingly improved effect can be expected. In one embodiment, about 0.05 to 1.0% by weight of initiator is used in the polymerizable compositions. Actinic radiation is commonly provided by any number of sources commercially available from companies such as Fusion UV Systems, Inc., Gaithersburg, Md. It is common knowledge among those skilled in the art to match the lamp emission with photoinitiator absorption for greatest efficiency. Absorbed doses in the range of 50-500 mJ/cm² are commonly used.

When the radiation curable monomer or oligomer comprises at least one group polymerizable by a cationic catalyst, the curing energy is usually actinic radiation such as ultraviolet or visible radiation, or thermal radiation. It is necessary to add a source of cations to the composition to initiate reaction on application of curing energy. The useful catalysts and initiators are salts comprised of (1) a thermally or photochemically reactive cationic portion, which serves as the latent source of Bronsted or Lewis acid (and, optionally, free radicals) necessary to initiate or catalyze polymerization and (2) a nonnucleophilic counteranion. Particular examples of such catalysts and intitators may be found in U.S. Pat. No. 5,514,728 and include Irgacure® 250 (iodonium type, available from Ciba Specialty Chemicals) and SarCat K185 (sulfonium type, available from Sartomer Company).

The nanocomposites described above may also be prepared by dissolving the plurality of nanoparticles and the organic matrix in a solvent, e.g. methylene chloride, and subsequently removing the solvent by evaporation.

The relative amounts of the nanoparticles and the organic matrix used in the nanocomposite disclosed herein may depend on the desired properties of the nanocomposite, such as optical and physical properties including refractive index, stiffness, hardness, gas permeability, durability, electrical conductivity, etc. The desired properties of the nanocomposite may depend on the application in which it is used. The amount of the plurality of nanoparticles used in the nanocomposite may also depend on the properties of the nanoparticles and the organic matrix.

In one embodiment, the plurality of nanoparticles may be used to increase the refractive index of an organic matrix, and the plurality of nanoparticles are present in an amount such that the refractive index of the nanocomposite is at least 0.01 greater than the refractive index of the organic matrix. Most polymers that are used as organic matrices have a refractive index no greater than 1.6. In one embodiment, the plurality of nanoparticles are present in an amount such that the nanocomposite has a refractive index of at least 1.61. In another embodiment, the plurality of nanoparticles are present in an amount of 50 weight % or less, relative to the weight of the organic matrix. In yet another embodiment, the plurality of nanoparticles are present in an amount of 25 volume % or less, relative to the volume of the organic matrix.

The nanocomposite disclosed herein may be used in a variety of applications and devices. For example, the nanocomposite disclosed herein may be used as quantum dots in semiconductor applications, or as materials used to track and label molecular processes in living cells and in vitro biological assays. The nanocomposite disclosed herein may also be used as an encapsulant in a light emitting devices or formed into an article such as a lens, prism, film, waveguide, etc. The nanocomposite disclosed herein may be used as a brightness enhancement film for back-lit electronic displays in computer monitors or cell phones. In one embodiment, the nanocomposite has a haze value of less than 5% in order to be useful in optical applications. The term “haze value” refers to the amount of light transmitted by an article and scattered outside a solid angle of 2.5 degrees from the light beam axis.

The examples described below are presented for illustration purposes only and are not intended to limit the scope of the invention in any way.

### EXAMPLES

Nanoparticles and Their Preparation

Preparation of H₂S in Isopropanol

A solution containing 0.200 g of zinc acetate dihydrate (0.00091 mole) in 10 mL dimethylformamide (DMF) was prepared. Another solution containing H₂S in isopropanol (IPA) was prepared by passing a stream of fine bubbles of the H₂S gas through the IPA for 24 hours, after which time it was assumed that the solution was saturated. The zinc acetate solution was titrated with the H₂S solution until lead acetate paper indicated the presence of excess H₂S. From this titration was determined the volume of the H₂S solution having 0.00083 mole of H₂S (10 mole % excess of zinc over H₂S). In order to prepare solutions for the following examples, this determined volume was multiplied by 10 and then IPA was added to make a total volume of 50 mL.

Nanoparticle NP-1

A solution was prepared by dissolving 2.0 g of zinc acetate dihydrate (0.0091 mole) and 0.06 g of 2-phenoxybenzoic acid in 40 mL of DMF. This was poured into 50 mL of the H₂S solution described above, containing 0.0083 mole of H₂S in IPA, wth strong stirring agitation. To the resulting mixture was added with stirring 100 mL of water. The resulting mixture was allowed to stand at ambient conditions. A precipitate was formed over a day and was separated by centrifugation and washed with water and IPA. After drying overnight in a vacuum desiccator, a small amount of the solid was dissolved in DMF using ultrasonic agitation. This solution was examined using UV-VIS spectroscopy, and a shoulder on the absorption curve occurred at 290 nm, corresponding to an average particle size of 3.0 nm. Preparation of NP-1 was repeated and the average particle size was 3.6 nm.

Nanoparticles NP-2 to NP-17

Nanoparticles NP-2 to NP-17 were prepared as described for Nanoparticle NP-1, except that different carboxylic acids were used. The amount of the carboxylic acid was 0.06 g in each example, therefore the mole ratio of carboxylic acid to zinc acetate varied. A summary of the nanoparticles is listed in Table 1. The mole ratios of carboxylic acid to zinc acetate ranged from 0.022 to 0.048, and the average particle sizes ranged from 3 to 8 nm.

TABLE 1

| | | | Mole | |
|---|---|---|---|---|
| | | | Ratio of | Average |
| | | MW of | Carboxylic | Particle |
| Nano- | | Carboxylic | Acid to Zinc | Size |
| particle | Carboxylic Acid | Acid | Acetate* | (nm) |
| NP-1 | 2-phenoxybenzoic acid | 214 | 0.03 | 3.0, 3.6 |
| NP-2 | 3-phenylpropionic acid | 150 | 0.044 | 4.5 |
| NP-3 | 2-phenylbutyric acid | 164 | 0.04 | 3.8 |
| NP-4 | 4-phenylbutyric acid | 164 | 0.04 | 4.0 |
| NP-5 | 2-naphthoxyacetic acid | 202 | 0.032 | 3.2 |
| NP-6 | 3-phenoxypropionic acid | 166 | 0.04 | 5.0 |
| NP-7 | 1-naphthylacetic acid | 186 | 0.035 | 4.6 |
| NP-8 | triphenylacetic acid | 288 | 0.023 | 4.0 |
| NP-9 | 5-phenylvaleric acid | 178 | 0.037 | 4.2 |
| NP-10 | benzoic acid | 136 | 0.048 | NM |
| NP-11 | phenoxyacetic acid | 152 | 0.043 | NM |
| NP-12 | 2-phenoxypropionic acid | 166 | 0.04 | NM |
| NP-13 | 3-phenylbutyric acid | 164 | 0.04 | NM |
| NP-14 | 2-phenoxybutyric acid | 180 | 0.037 | NM |
| NP-15 | 2-methoxyphenylacetic | 166 | 0.04 | NM |
| | acid | | | |
| NP-16 | 3,3,3-triphenylpropionic | 302 | 0.022 | NM |
| | acid | | | |
| NP-17 | 4-phenylcinnamic acid | 240 | 0.027 | NM |

NM = not measured
*MW of zinc acetate is 219

Curable Nanocomposites and Their Preparation
Curable Nanocomposite CN-1

5 g of NP-1 were mixed with 5 g of 2-carboxyethyl acrylate (CEA). The mixture was allowed to sit overnight and was then agitated for 40 minutes using an ultrasonic disperser, with ultrasonic horn of 30 kHz with power around 20 W/cm² at the horn end, and with water cooling. During this process, the turbid composite became more and more transparent, and after complete dissolution of the nanoparticles, there was formed a transparent and curable nanocomposite having a refractive index of 1.615. This nanocomposite was a viscous liquid.

To the viscous liquid was added 0.05 g of Darocur® 1173 (2-hydroxy-2-methyl-1-phenyl-propan-1-one, a photoinitiator available from Ciba Specialty Chemicals). A film of the curable nanocomposite having a thickness of 100 um was prepared between two polyester films. After irradiating with a low pressure mercury lamp for 2 minutes, the polyester films were pulled away, leaving a transparent film of the cured nanocomposite.

Curable Nanocomposites CN-2 to CN-14

Curable nanocomposites CN-2 to CN-14 were prepared as described for CN-1 except that different nanoparticles were used. For each nanoparticle/CEA combination, dissolution of the nanoparticles in CEA was evaluated qualitatively according to the descriptions below. A summary is provided in Table 2.
good: mixture of nanoparticles and CEA became a white liquid during the first minute of agitation using the ultrasonic disperser; the white liquid became opalescent and during the next ten minutes became more and more transparent
fair: mixture of nanoparticles and CEA became a white liquid during agitation using the ultrasonic disperser; the white liquid became more and more transparent over one hour
poor: mixture of nanoparticles and CEA became a white liquid during agitation using the ultrasonic disperser, but remained a white liquid even after one hour of agitation

none: mixture of nanoparticles and CEA became a white during agitation using the ultrasonic disperser, but the nanoparticles precipitated

TABLE 2

| Curable | | | Dissolution |
|---|---|---|---|
| Nanocomposite | Nanoparticle | Carboxylic Acid | in CEA |
| CN-1 | NP-1 | 2-phenoxybenzoic acid | good¹ |
| CN-2 | NP-9 | 5-phenylvaleric acid | good² |
| CN-3 | NP-3 | 2-phenylbutyric acid | fair |
| CN-4 | NP-13 | 3-phenylbutyric acid | fair |
| CN-5 | NP-4 | 4-phenylbutyric acid | good |
| CN-6 | NP-2 | 3-phenylpropionic acid | fair |
| CN-7 | NP-7 | 1-naphthylacetic acid | good² |
| CN-8 | NP-5 | 2-naphthoxyacetic acid | poor |
| CN-9 | NP-14 | 2-phenoxybutyric acid | poor |
| CN-10 | NP-11 | phenoxyacetic acid | poor |
| CN-11 | NP-15 | 2-methoxyphenylacetic | NM |
| | | acid | |
| CN-12 | NP-10 | benzoic acid | none |
| CN-13 | NP-12 | 2-phenoxypropionic acid | poor |
| CN-14 | NP-6 | 3-phenoxypropionic acid | poor |

NM = not measured
¹also, dissolution was very good in 1:2 CEA/PEA, refractive index = 1.64 (PEA = phenoxyethyl acrylate)
²dissolution was measured in 1:2 CEA/PEA

Comparison of Refractive Index Before and After Curing

The refractive index was measured for nanocomposites containing NP-2 both before and after the nanocomposites were cured into films as described for CN-1. The viscosity of the uncured nanocomposite increased significantly as the nanoparticle content was increased. The maximum concentration of nanoparticles in the nanocomposite was 50 weight % or 25 volume %, and was reached when the uncured nanocomposite was barely moldable. The results are shown in Table 3. The results show that the refractive indices for the cured nanocomposites were greater by at least 0.10 if NP-2 was present. In addition, the cured nanocomposites were transparent and flexible.

TABLE 3

| | Without NP-2 | | With NP-2¹ | |
|---|---|---|---|---|
| Monomer | Before Curing | After Curing | Before Curing | After Curing |
| CEA | 1.455 | 1.493 | 1.615 | 1.63 |
| 70/30 | 1.495 | 1.538 | 1.61 | 1.64 |
| PEA²/ | | | | |
| CEA | | | | |

¹NP-2 present at 20% volume concentration
²Refractive index of PEA before curing is 1.5180

Because CEA has a low refractive index, it was replaced with PEA which has a higher refractive index. After thorough removal of water from the nanoparticle surface, up to 70% of the CEA could be replaced by PEA. The refractive index increased from 1.455 to 1.495 before curing. With the addition of 20 volume % of NP-2, the refractive index after curing was 1.64. Films up to 100 micron thick, with haze values not more than 3%, were obtained. The term “haze value” refers to the amount of light transmitted by an article and scattered outside a solid angle of 2.5 degrees from the light beam axis.

Different ways of removing the absorbed and adsorbed water from the nanoparticles were studied, including air and vacuum drying, treatment in boiling toluene or xylene. The best results were obtained by the treatment of the nanoparticles in boiling toluene for 8 hours. Drying was made in boiling toluene as follows: A three-neck flask was supplied with a reflux condenser. Into the flask was placed CaCl to absorb water and some quantity of toluene. Nanoparticle powder was placed in small beaker placed in center of flask, which was heated up to boiling of toluene and process was continued for 8 hours. The hot toluene formed an azeotrope with water and removed water from the surface of the nanoparticles. After that the nanoparticles were removed from the flask and dried in air. Xylene was used similarly. Xylene has a higher boiling temperature that is good for removing water, but it was dried from the nanoparticle more slowly than toluene.

Air drying was made in a desiccator at 60-70° C. during 10 hours. At higher temperature nanoparticles become a little yellow. Any convenient apparatus can be used. Vacuum drying was also used by heating the nanoparticles in a glass tube to 80° C. in a vacuum of about 10⁻² mm of mercury for about 2 hours. The best results were received by toluene and xylene drying (good dissolution of nanoparticles into monomer mixture, absence of color of nanoparticles after drying).

Water and solvents may be adsorbed on the nanoparticles during formation of the nanocomposite. Subsequent evaporation of these solvents causes the formation of large voids in the nanocomposite. For the films of the same composition and different nanoparticles, the haze value varied from 96 to 12%. In general, larger and longer carboxylic acids gave low haze values. However, when the carboxylic acid was triphenylacetic acid, a yellow color appeared. Also, the solutions with very large acids were not as stable.

By elimination of solvents and water through long drying, the haze value could be decreased to 6% for a 100 micron film of 8 volume % of ZnS in polycarbonate.

Comparison of Organic Matrices

Nanocomposites were prepared using nanoparticles made with a carboxylic acid comprising at least one aryl group, such as NP-9 wherein the carboxylic acid is 5-phenylvaleric acid, and organic matrices wherein monomers such as PEA are diluted with the carboxylic acid. Typically, an excess of about 30% of the carboxylic acid was needed to stabilize the solution so that the nanoparticles did not precipitate. However, the resulting unpolymerized solution was very viscous, and the cured nanocomposite was quite soft. If the monomer mixture consisted of 30% CEA in PEA, then no extra carboxylic acid was needed, the resulting solution was stable, and the cured composite had good properties. If CEA was used in place of the carboxylic acid, poor results were obtained, because the CEA is soluble in water and precipitation with water addition removed the CEA from the nanoparticles. The results are summarized in Table 4.

TABLE 4

| | | Solution | Cured |
|---|---|---|---|
| Shell | Monomer | Viscosity | Nanocomposite |
| Higher acid | CEA | Good | Good |
| Higher acid | PEA + 30% excess | High | Soft |
| | higher acid | | |
| Higher acid | PEA + 30% CEA | Good | Good |

No matter what the carboxylic acid, the nanoparticles had to be dissolved in CEA first with ultrasonic agitation, and then the other monomer could be added. The combination of an acrylate group and a carboxylic acid group on the CEA is key to its use. There are very few commercially available monomers with that combination.

What is claimed is:

1. A nanocomposite comprising:
a plurality of nanoparticles, each nanoparticle comprising at least one metal sulfide nanocrystal having a surface modified with a carboxylic acid, wherein the carboxylic acid comprises at least one aryl group; and
an organic matrix.

2. The nanocomposite of claim 1 wherein the at least one metal sulfide nanocrystal comprises a transition metal sulfide nanocrystal, a Group IIA metal sulfide nanocrystal, or mixtures thereof.

3. The nanocomposite of claim 2 wherein the transition metal sulfide nanocrystal comprises a zinc sulfide nanocrystal of sphalerite crystal form.

4. The nanocomposite of claim 1 wherein the nanoparticle has an average particle size of 50 nm or less.

5. The nanocomposite of claim 1 wherein the carboxylic acid comprising at least one aryl group has a molecular weight of from 60 to 1000.

6. The nanocomposite of claim 1 wherein the carboxylic acid comprising at least one aryl group is represented by the formula:
Ar—L¹—CO₂H
wherein L¹ comprises an alkylene residue of from 1 to 10 C atoms, and wherein the alkylene residue is saturated, unsaturated, straight-chained, branched, or alicyclic; and
Ar comprises a phenyl, phenoxy, naphthyl, naphthoxy, fluorenyl, phenylthio, or naphthylthio group.

7. The nanocomposite of claim 6 wherein the alkylene residue is methylene, ethylene, propylene, butylene, or pentylene.

8. The nanocomposite of claim 1, wherein the carboxylic acid comprising at least one aryl group is 3-phenylpropionic acid; 4-phenylbutyric acid; 5-phenylvaleric acid; 2-phenylbutyric acid; 3-phenylbutyric acid; 1-napthylacetic acid; 3,3,3-triphenylpropionic acid; triphenylacetic acid; 2-methoxyphenylacetic acid; 3-methoxyphenylacetic acid; 4-methoxyphenylacetic acid; 4-phenylcinnamic acid; or mixtures thereof.

9. The nanocomposite of claim 1, wherein the carboxylic acid comprising at least one aryl group is represented by the formula:
Ar—L²—CO₂H
wherein L² comprises a phenylene or napthylene residue; and
Ar comprises a phenyl, phenoxy, naphthyl, naphthoxy, fluorenyl, phenylthio, or naphthylthio group.

10. The nanocomposite of claim 1, wherein the carboxylic acid comprising at least one aryl group is 2-phenoxybenzoic acid; 3-phenoxybenzoic acid; 4-phenoxybenzoic acid; 2-phenylbenzoic acid; 3-phenylbenzoic acid; 4-phenylbenzoic acid, or mixtures thereof.

11. The nanocomposite of claim 1, wherein the organic matrix is a polyolefin, polystyrene, polyacrylate, polymethacrylate, polyacrylic acid, polymethacrylic acid, polyether, polybutadiene, polyisoprene, polyvinylchloride, polyvinylalcohol, polyvinyl acetate, polyester, polyurethane, polyurea, polycarbonate, polyamide, polyimide, cellulose, or mixtures thereof.

12. The nanocomposite of claim 1, wherein the organic matrix is a copolymer of a polyolefin, polystyrene, polyacrylate, polymethacrylate, polyacrylic acid, polymethacrylic acid, polyether, polybutadiene, polyisoprene, polyvinylchloride, polyvinylalcohol, polyvinyl acetate, polyester, polyurethane, polyurea, polycarbonate, polyamide, polyimide, or cellulose.

13. A method of preparing a nanocomposite, the method comprising:
(a) providing a plurality of nanoparticles, each nanoparticle comprising at least one metal sulfide nanocrystal having a surface modified with a carboxylic acid, wherein the carboxylic acid comprises at least one aryl group;
(b) providing an organic matrix comprising a thermoplastic polymer; and
(c) mixing the plurality of nanoparticles with the organic matrix to effect dissolution of the plurality of nanoparticles.

14. A method of preparing a nanocomposite, the method comprising:
(a) providing a plurality of nanoparticles, each nanoparticle comprising at least one metal sulfide nanocrystal having a surface modified with a carboxylic acid, wherein the carboxylic acid comprises at least one aryl group;
(b) providing an organic matrix comprising a radiation curable monomer, a radiation curable oligomer, or mixtures thereof; and
(c) mixing the plurality of nanoparticles with the organic matrix to effect dissolution of the plurality of nanoparticles.

15. The nanocomposite of claim 1, wherein the organic matrix comprises a radiation curable monomer, radiation curable oligomer, or mixtures thereof.

16. The nanocomposite of claim 15, wherein the radiation curable monomer or the radiation curable oligomer comprises an acrylate, methacrylate, or styrenic group, or mixtures thereof.

17. The nanocomposite of claim 15, wherein the radiation curable monomer is 2-carboxyethyl acrylate, phenoxyethylacrylate, or mixtures thereof.

18. The method of claim 14 further comprising:
(d) adding a photoinitiator; and
(e) curing with actinic radiation.

19. The method of claim 14 further comprising:
(d) adding a thermal initiator; and
(e) curing with thermal radiation.

20. The nanocomposite of claim 1 having a refractive index of at least 1.61.

21. The nanocomposite of claim 1 having a refractive index that is at least 0.01 greater than the refractive index of the organic matrix.

22. The nanocomposite of claim 1, wherein the plurality of nanoparticles are present in an amount of 50 weight % or less, relative to the weight of the organic matrix.

23. The nanocomposite of claim 1, wherein the plurality of nanoparticles are present in an amount of 25 volume % or less, relative to the volume of the organic matrix.

24. The nanocomposite of claim 1 having a haze value of less than 5%.
